(19) United States
(12) Patent Application Publication
(10) Pub. No.: US 2013/0121896 A1
(43) Pub. Date: May 16, 2013

(54) SYSTEMS TO CONTROL FLUID FLOW IN DENSITY-BASED FLUID SEPARATION

(71) Applicants: Jonathan Erik Lundt, Seattle, WA (US); Arturo Bernardo Ramirez, Seattle, WA (US); Joshua John Nordberg, Bainbridge Island, WA (US); Paul Jared Spatafore, Bothell, WA (US)

(72) Inventors: Jonathan Erik Lundt, Seattle, WA (US); Arturo Bernardo Ramirez, Seattle, WA (US); Joshua John Nordberg, Bainbridge Island, WA (US); Paul Jared Spatafore, Bothell, WA (US)

(21) Appl. No.: 13/421,268

(22) Filed: Mar. 15, 2012

Related U.S. Application Data
(60) Provisional application No. 61/560,194, filed on Nov. 15, 2011.

(51) Int. Cl. B04B 15/00; B01L 3/00

(52) U.S. Cl. 422/548; 422/500

(57) ABSTRACT

Systems and methods that can be used to detect materials of interest in a suspension are disclosed. A suspension suspected of containing a material of interest and a float are added to a tube. When the tube, float and suspension are centrifuged together, the float expands the axial length of a layer that contains the material of interest between the outer surface of the main body of the float and the inner wall of the tube. The float includes features located on the main body of the float that enhance mixing of various agents to be added to the suspension. The features may also increase the flow of the suspension fluid and materials around the float during centrifugation.

### CROSS-REFERENCE TO RELATED APPLICATION

This application claims the benefit of Provisional Application No. 61/560,194, filed Nov. 15, 2011.

### TECHNICAL FIELD

This disclosure relates generally to density-based fluid separation and, in particular, to tube and float systems for the separation and axial expansion of constituent suspension components layered by centrifugation.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as ova, fetal cells, endothelial cells, parasites, bacteria, and inflammatory cells, and viruses, including HIV, cytomegalovirus, hepatitis C virus, and Epstein-Barr virus. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 5 CTCs is considered clinically relevant in the diagnosis and treatment of a cancer patient. However, detecting even 1 CTC in a 7.5 ml blood sample is equivalent to detecting 1 CTC in a background of about 40 billion red and white blood cells. Using existing techniques to find as few as 5 CTCs in a whole blood sample is extremely time consuming, costly and may be impossible to accomplish. As a result, practitioners, researchers, and those working with suspensions continue to seek systems and methods to more efficiently and accurately analyze suspensions for the presence of materials of interest.

### SUMMARY

Systems and methods that can be used to detect materials of interest in a suspension are disclosed. A suspension suspected of containing a material of interest, also called a “target material,” and a float are added to a tube. When the tube, float and suspension are centrifuged together, the float expands the axial length of a layer that contains the target material between the outer surface of the main body of the float and the inner wall of the tube. The float includes features located on the main body of the float that enhance mixing of various agents added to the suspension. The features may also increase the flow of the suspension fluid and materials around the float during centrifugation.

### DESCRIPTION OF THE DRAWINGS

FIGS. 1A-1B show isometric views of two example tube and float systems.

FIGS. 2A-2D show four floats with examples of different structural elements.

FIG. 3A shows an isometric view of a float with an example arrangement of features formed in the outside surface of the main body of the float.

FIGS. 3B-3C show cross-sectional views of the float along a line I-I shown in FIG. 3A.

FIG. 4 shows a cut-away snapshot of a tube that contains a suspension and a float during centrifugation.

FIGS. 5A-5D show isometric views of four example floats with different feature patterns and feature arrangements.

FIGS. 6A-6D show isometric views of four example floats with different feature patterns and feature arrangements.

### DETAILED DESCRIPTION

The detailed description is organized into two subsections: (1) A general description of tube and float systems is provided in a first subsection. (2) A description of floats with various example feature patterns and feature arrangements is provided in a second subsection.

### Tube and Float Systems

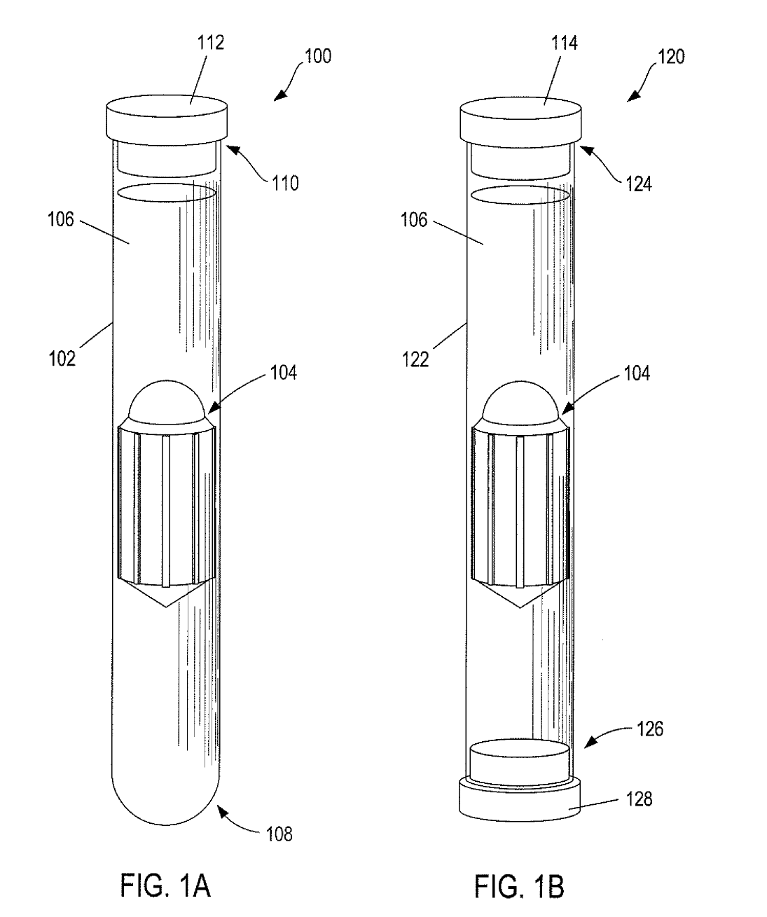

FIG. 1A shows an isometric view of an example tube and float system 100. The system 100 includes a tube 102 and a programmable float 104 suspended within a suspension 106. In the example of FIG. 1A, the tube 102 has a circular cross-section, a first closed end 108, and a second open end 110. The open end 110 is sized to receive a stopper or cap 112. A tube may also have two open ends that are sized to receive stoppers or caps, such as the tube 122 of an example tube and float system 120 shown FIG. 1B. The system 120 is similar to the system 100 except the tube 102 of the system 102 is replaced by a tube 122 that includes two open ends 124 and 126 configured to receive the cap 112 and a cap 128, respectively. The tubes 102 and 122 have a generally cylindrical geometry, but may also have a tapered geometry that widens toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as flexible plastic or another suitable material.

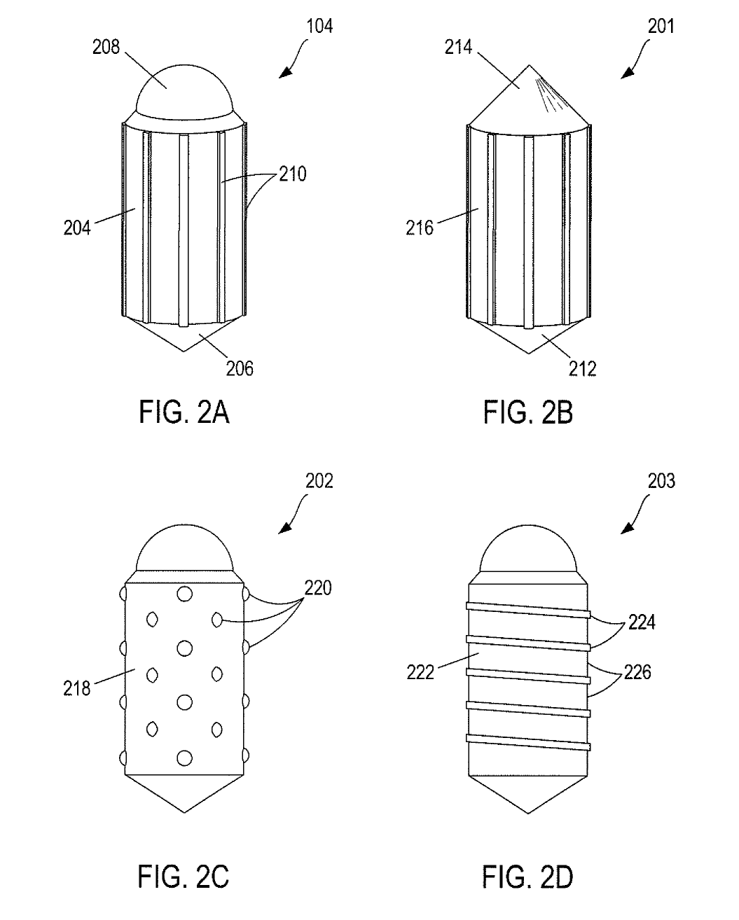

FIGS. 2A-2D shows four examples of floats 104 and 201-203 with different types of structural elements and end caps. In FIG. 2A, the float 104, shown in FIG. 1, includes a main body 204, a cone-shaped end cap 206, a dome-shaped end cap 208, and structural elements in the form of splines 210 that are radially spaced and axially oriented. The splines 210 provide a sealing engagement with the inner wall of the tube 102. In other embodiments, the number of splines, spline spacing, and spline thickness can be independently varied. The splines 210 can also be broken or segmented. The main body 204 is sized to have an outer diameter that is less than the inner diameter of the tube 102, thereby defining fluid retention channels between the outer surface of the body 204 and the inner wall of the tube 102. The outer surfaces of the body 204 between the splines 210 can be flat, curved or have another suitable geometry. In the example of FIG. 2A, the splines 208 and the body 204 form a single structure. Embodiments include other types of geometric shapes for float end caps. In FIG. 2B, an example float 201 has two cone-shaped end caps 212 and 214. The main body 216 of the float 201 includes the same structural elements (i.e., splines) as the float 104. A float can also include two dome-shaped end caps. Float end caps can be configured with other geometric shapes and are not intended to be limited to the shapes described herein. In other embodiments, the main body of a float can include a variety of different structural elements for separating target materials, supporting the tube wall, or directing the suspension fluid around the float during centrifugation. FIGS. 2C and 2D show examples of two different types of main body structural elements. Embodiments are not intended to be limited to these two examples. In FIG. 2C, the main body 218 of the float 202 is similar to the float 104 except the main body 218 includes a number of protrusions 220 that provide support for the deformable tube. In other embodiments, the number and pattern of protrusions can be varied. In FIG. 2D, the main body 222 of the float 203 includes a single continuous helical structure or ridge 224 that spirals around the main body 222 creating a helical channel 226. In other embodiments, the helical ridge 224 can be rounded or broken or segmented to allow fluid to flow between adjacent turns of the helical ridge 224. In other embodiments, the helical ridge spacing and rib thickness can be independently varied.

A float can be composed of a variety of different materials including, but are not limited to, rigid organic or inorganic materials, and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (“PPO”), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer and others.

### Examples of Floats with Features

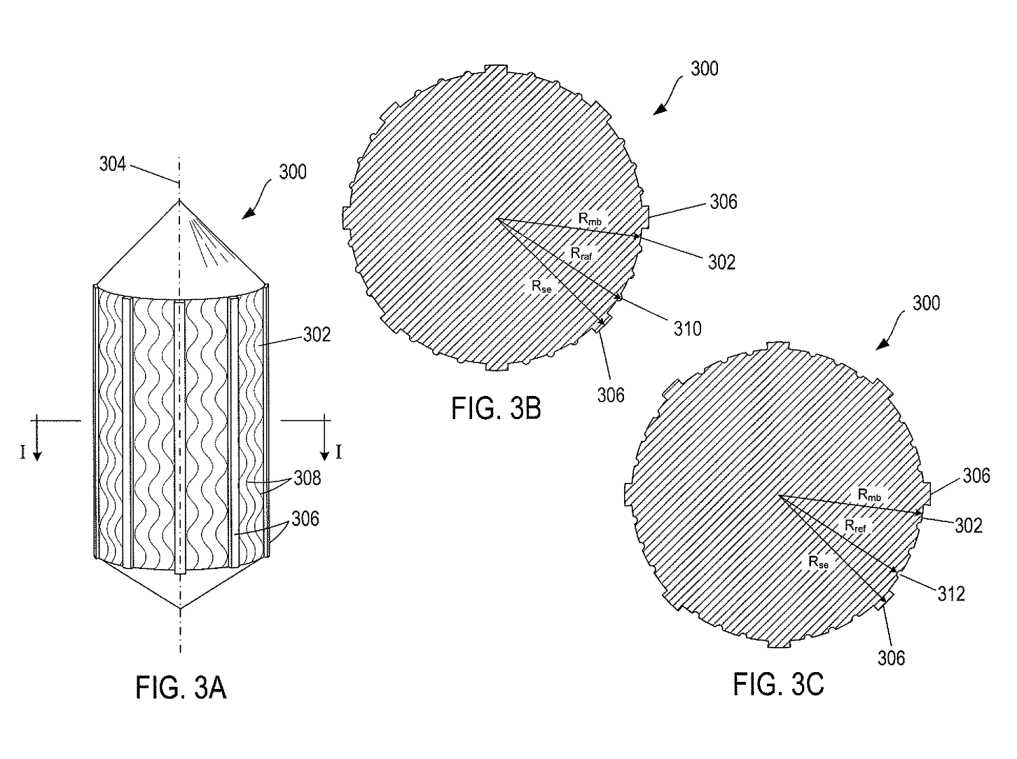

Tube and float system embodiments in which the float has one or more features formed in the outer surface of the main body of the float are now described. The features can be raised portions of the outer surface of the main body which are called “raised features,” or the features can be recessed portions of the outer surface of the float which are called “recessed features.” FIG. 3A shows an isometric view of a float 300 with an example arrangement of features formed in the main body 302 of the float 300. Dot-dashed line 304 represents the central or highest-symmetry axis of the float 300. The main body 302 includes structural elements in form of radially spaced and axially oriented splines 306 as described above with reference to FIGS. 2A-2B. As shown in the example of FIG. 3A, within the channels between the splines 306, the main body 302 includes serpentine features 308 that span the length of the main body 302 and oriented substantially parallel to the central axis 304. The features 308 can be raised features or recessed features. FIG. 3B shows a cross-sectional view of the float 300 along a line I-I shown in FIG. 3A with raised features. In FIG. 3B, R_{raf} represents the radial distance from a raised feature 310 to the center of the float 300, R_{mb} represents the radial distance from the main body outer surface to the center of the float 300, and Rₛₑ represents the radial distance from a structural element 306 to the center of the float 300. In general, for raised features, the raised feature radial distance R_{raf} is greater than the main body radial distance R_{mb} and is less than the structural element radial distance Rₛₑ (i.e., R_{mb}<R_{ref}<Rₛₑ). FIG. 3C shows a cross-sectional view of the float 300 along the same line I-I with recessed features. In FIG. 3C, R_{ref} represents the radial distance from a recessed feature 312 to the center of the float 300. In general, for recessed features, the recessed feature radial distance R_{ref} is less than both the main body radial distance R_{mb} and the structural element radial distance Rₛₑ (i.e., R_{ref}<R_{mb}<Rₛₑ).

A suspension and a float with features are added to a tube and the tube is centrifuged to cause the various materials to separate axially along the tube according their associated densities. Centrifugation causes the suspension materials and fluids to flow between the main body of the float and the inner wall of the tube with higher density materials flowing downward and lower density materials flowing upward. Materials with densities similar to the density of the float migrate to the space between the main body of the float and the inner wall of the tube. However, during centrifugation, the features formed in the outer surface of the main body of the float perturb the flow of the suspension fluids and materials by creating localized microflows. A microflow is a portion of a fluid and suspended materials that flow in along a path for a short distance. In other words, as the suspension fluids and materials flow generally in upward and downward directions according to their associated densities, the fluids and materials flow over, along and around the features which causes the fluids and materials to form microflows that, in turn, combine with other microflows and may split into two or more microflows. For example, during centrifugation, portions of one microflow can be combined with another microflow and may even swirl as the materials and fluids of other microflows combine. In general, the features facilitate mixing of the suspension materials and fluids as the materials and fluids pass over the main body of the float during centrifugation.

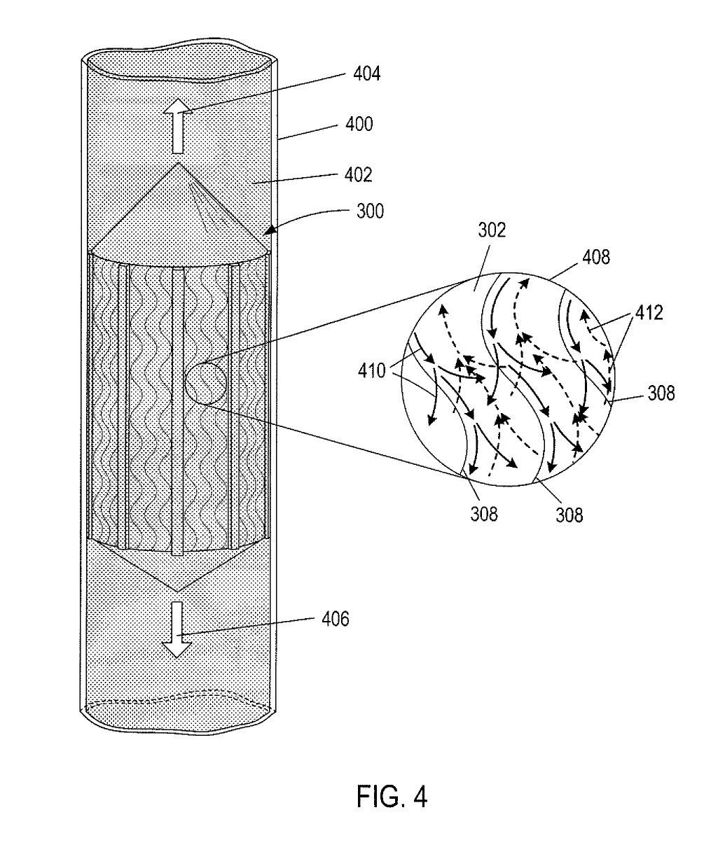

FIG. 4 shows a cut-away of a tube 400 that contains a suspension 402 and the float 300. Directional arrows 404 and 406 represent the directions low and high density materials travel, respectively, while the tube 400, suspension 402 and float 300 are centrifuged together. As the fluids and materials travel along the channels, the features 308 create microflows. FIG. 4 includes a magnified view 408 of a region of a channel during centrifugation. Microflows with an overall downward direction are represented by solid directional arrows 410, and microflows with an overall upward direction are represented by dashed directional arrows 412. The microflows represented by the directional arrows 410 and 412 are merely representative of the various intersecting paths the microflows travel along and are not intended to represent the actual flow of the fluid and materials. As shown in the example of FIG. 4, the features create the microflows that may split into two or more microflows and combine with other microflows to create microflow mixing while the materials in the microflows travel along the outer surface of the main body of the float to be separated according to the their associated densities.

When one or more agents are added to a suspension and the agents and suspension are centrifuged in a tube with a float with features, the features may facilitate interaction of the agents with the target material. For example, when the suspension added to the tube is a peripheral whole blood sample and the target material is a particular cell type, such as circulating tumor cells, various agents can be added to the tube to analyze and detect the target cells. Examples of agents that can be added to the tube with a whole blood sample include a fixing agent, a permeabilizing agent and a staining agent. The fixing agent, such as formalin, prevents the target cells from decaying and prevents further biological activity. The permeablizing agent disrupts the target cell membranes in order to introduce fluorescently labeled antibody probes to the interior of the target cells. The staining agent enhances microscopic imaging of the target cells. As described above with reference to FIG. 4, the features create microflows that mix the permeabilizing, fixing, and staining agents with the target cells to facilitate interaction between the target cells and the agents. As a result, proper fixation, permeabilization, and staining of the target cells may be facilitated by the features, which may increase the likelihood that the target cells can be detected and reduces the likelihood that the target cells may be washed away.

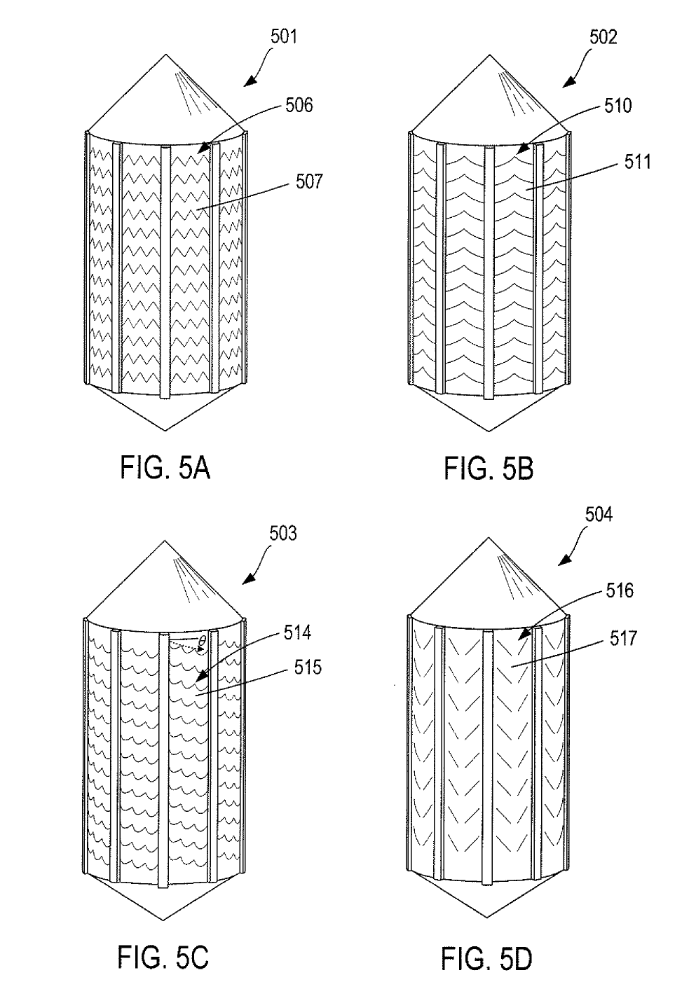

Floats with features are not intended to be limited to the feature pattern and feature arrangement formed on the outer surface of the main body of the float 300 described above. FIGS. 5A-5D show isometric views of four example floats 501-504, respectively. Each float has a different feature pattern and feature arrangement. In FIG. 5A, the float 501 has a circumferential sawtooth feature pattern 506 formed on the outer surface of the float main body 507 in the channels between the structural elements or splines. The feature arrangement is the sawtooth feature pattern repeated along the length of the main body 507 between the splines at regular intervals. In FIG. 5B, the float 502 has a circumferential wave-like feature pattern 510 formed on the outer surface of the float main body 511 in the channels between the structural elements or splines. The feature arrangement is the wave-like feature pattern repeated along the length of the main body 511 at regular intervals. The feature patterns 506 and 510 illustrated in FIGS. 5A and 5B are aligned with the circumference of the main body of the floats 501 and 502, respectively. In general, the feature pattern can have an angle, θ, with respect to the edge of the main body, where the angle θ can range from −90° to +90° with θ=0° corresponding to a circumferential feature pattern, such as the circumferential patterns 506 and 510. In FIG. 5C, the float 503 has an angled wave-like feature pattern 514 formed on the outer surface of the float main body 515 in the channels between the structural elements or splines in which the feature pattern 514 angle θ is less than 0°. As shown in the example of FIG. 5C, the feature arrangement is the angled wave-like feature pattern repeated along the length of the main body 511 at regular intervals. In other embodiments, the features can be discontinuous. For example in FIG. 5D, the feature pattern 516 of the float 504 is V-shaped or a chevron formed on the main body 517. In other embodiments, the features can be inverted V-shapes.

System embodiments also include float with features, but the floats do not have structural elements. The features are raised features the features satisfy the condition R_{mb}<R_{raf} and when the features are recessed features, the features satisfy the condition R_{ref}<R_{mb}, where R_{mb}, R_{raf}, and R_{ref} are described above with reference to FIGS. 3B-3C.

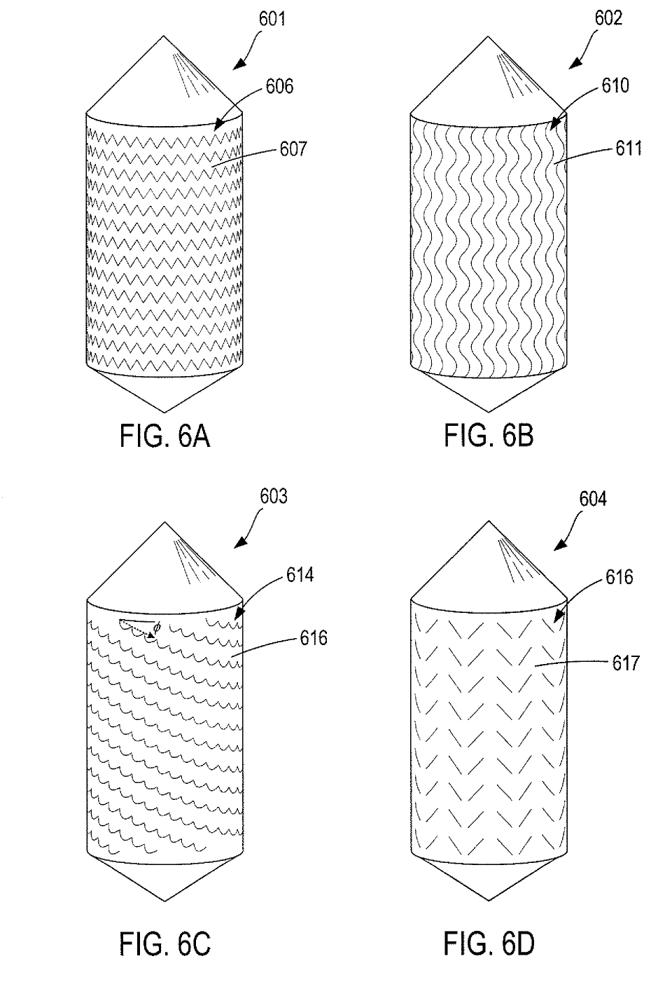

FIGS. 6A-6D show isometric views of four example floats 601-604, respectively. Each float has a different feature pattern and feature arrangement, but unlike the floats described above, the floats 601-604 do not include structural elements. In FIG. 6A, the float 601 has a circumferential sawtooth feature pattern 606 that wraps around the outer surface of the float main body 607. The feature arrangement is the feature pattern 606 repeated at regular intervals along the length of the main body 607. In FIG. 6B, the float 502 has a serpentine feature pattern 610 formed on the outer surface of the float main body 611 with each feature spanning the length of the main body 611. The feature arrangement is the serpentine features radially spaced around the main body outer surface. The feature patterns can have an angle, φ, with respect to the edge of the main body, where the angle φ can range from −90° to +90° with φ=0° corresponding to a circumferential feature pattern, such as the circumferential pattern 606. In FIG. 6C, the float 603 has a wave-like feature pattern 614 with an angle φ less than 0° formed on the outer surface of the float main body 615. As shown in the example of FIG. 6C, the feature arrangement is the angled wave-like feature pattern repeated at regular intervals along the length of the main body 615. In other embodiments, the features can be discontinuous. For example in FIG. 6D, the feature pattern 616 of the float 604 is V-shaped or a chevron formed on the main body 617. In other embodiments, the features can be inverted V-shapes.

It should be understood that the float and float and tube system described and discussed herein may be used with any appropriate biological sample, such as blood, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. The foregoing description, for purposes of explanation, used specific nomenclature to provide a thorough understanding of the disclosure. However, it will be apparent to one skilled in the art that the specific details are not required in order to practice the systems and methods described herein. Note that feature patterns and arrangements described above with reference to FIGS. 5A-5D and 6A-6D are not intended to be exhaustive of the possible feature patterns and arrangements. The feature patterns and arrangements can be varied. The features also do not have to be patterned and the feature arrangements do not have to regularly spaced features. In other embodiments, the features can be irregularly shaped. In other embodiments, a feature pattern or irregularly-shaped features can have irregular arrangements on the outer surface of a main body. In other embodiments, a float can be configured with a combination of raised features and recessed features. For example, the features of a float can be alternating raised and recessed features. In other embodiments, the features can alternate between raised features in one channel and recessed in an adjacent channel.

The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A system for separating materials of a suspension, the system comprising:
a tube having an elongated sidewall; and
a float to be inserted in the tube, wherein the float includes a main body with an outer surface having one or more features, the one or more features to facilitate mixing of the suspension materials and fluids as the materials and fluids pass between the main body the sidewall during centrifugation.

2. The system of claim 1, wherein the one or more features are raised features that satisfy a condition given by:
R_{mb}<R_{raf}
where R_{raf} represents a radial distance from a raised feature to the center of the float, and R_{mb} represents a radial distance from the main body outer surface to the center of the float.

3. The system of claim 1, wherein the one or more features are recessed features that satisfy a condition given by:
R_{ref}<R_{mb}
where R_{ref} represents a radial distance from a recessed feature to the center of the float, and R_{mb} represents a radial distance from the main body outer surface to the center of the float.

4. The system of claim 1, wherein the main body further comprises one or more structural elements and wherein the one or more features are raised features that satisfy a condition given by:
R_{mb}<R_{raf}<Rₛₑ
where R_{raf} represents a radial distance from a raised feature to the center of the float, R_{mb} represents a radial distance from the main body outer surface to the center of the float, and Rₛₑ represents a radial distance from a structural element to the center of the float.

5. The system of claim 1, wherein the main body further comprises one or more structural elements and wherein the one or more features are recessed features that satisfy a condition given by:
R_{ref}<R_{mb}<Rₛₑ
where R_{ref} represents a radial distance from a recessed feature to the center of the float, R_{mb} represents a radial distance from the main body outer surface to the center of the float, and Rₛₑ represents a radial distance from a structural element to the center of the float.

6. The system of claim 1, wherein the one or more features are a combination of raised and recessed features.

7. The system of claim 1, wherein the one or more features have a feature pattern that wraps around the outer surface of the main body.

8. The system of claim 1, wherein the one or more features have a feature pattern oriented parallel to a central axis of the float.

9. The system of claim 1, wherein the one or more features have an irregular feature pattern.

10. A float for use in a tube and float system, the float comprising:
a main body with an outer surface; and
one or more features in the outer surface, wherein the features are to perturb the flow of fluids and materials of a suspension when the float is centrifuged in a tube with the suspension.

11. The float of claim 10, wherein the one or more features are raised features that satisfy a condition given by:
R_{mb}<R_{raf}
where R_{raf} represents a radial distance from a raised feature to the center of the float, and R_{mb} represents a radial distance from the main body outer surface to the center of the float.

12. The float of claim 10, wherein the one or more features are recessed features that satisfy a condition given by:
R_{ref}<R_{mb}
where R_{ref} represents a radial distance from a recessed feature to the center of the float, and R_{mb} represents a radial distance from the main body outer surface to the center of the float.

13. The float of claim 10, wherein the main body further comprises one or more structural elements and wherein the one or more features are raised features that satisfy a condition given by:
R_{mb}<R_{raf}<Rₛₑ
where R_{raf} represents a radial distance from a raised feature to the center of the float, R_{mb} represents a radial distance from the main body outer surface to the center of the float, and Rₛₑ represents a radial distance from a structural element to the center of the float.

14. The float of claim 10, wherein the main body further comprises one or more structural elements and wherein the one or more features are recessed features that satisfy a condition given by:
R_{ref}<R_{mb}<Rₛₑ
where R_{ref} represents a radial distance from a recessed feature to the center of the float, R_{mb} represents a radial distance from the main body outer surface to the center of the float, and Rₛₑ represents a radial distance from a structural element to the center of the float.

15. The float of claim 10, wherein the one or more features are a combination of raised and recessed features.

16. The float of claim 10, wherein the one or more features have a feature pattern that wraps around the outer surface of the main body.

17. The float of claim 10, wherein the one or more features have a feature pattern oriented parallel to a central axis of the float.

18. The float of claim 10, wherein the one or more features have an irregular feature pattern.
